(19) United States
(12) Patent Application Publication
(10) Pub. No.: US 2023/0273622 A1
(43) Pub. Date: Aug. 31, 2023

(54) METHOD, SYSTEM, AND NON-TRANSITORY COMPUTER-READABLE RECORDING MEDIUM FOR CONTROLLING PLURALITY OF AUTOMATED GUIDED VEHICLES

(71) Applicant: SERVOSTAR CO., LTD., Seoul (KR)

(72) Inventors: Gi Jin LEE, Seoul (KR); Seol Min JEONG, Seoul (KR)

(73) Assignee: SERVOSTAR CO., LTD., Seoul (KR)

(21) Appl. No.: 18/143,713

(22) Filed: May 5, 2023

Related U.S. Application Data
(63) Continuation of application No. PCT/KR2021/009090, filed on Jul. 15, 2021.

(51) Int. Cl. G05D 1/02

(52) U.S. Cl. CPC G05D 1/0289; G05D 2201/0216

(57) ABSTRACT

A method for controlling a plurality of automated guided vehicles (AGVs) includes acquiring real-time information regarding positions of the plurality of AGVs moving along an automated guided vehicle route (AGV route), setting a blocking area for each of the AGVs based on the information regarding the positions of the plurality of AGVs acquired in the step of acquiring the real-time information, and controlling movements of the plurality of AGVs with reference to the blocking area. When an AGV is located at any one of plurality of points in the AGV route, a point at which the AGV is located and a movement line adjacent thereto are set as the blocking area. When the AGV is located on any one of movement lines in the AGV route, movement lines on which the AGV is located and through which the AGV has just passed are set as the blocking area.

### CROSS-REFERENCE TO RELATED APPLICATION

This application is a continuation application of Patent Cooperation Treaty (PCT) International Application No. PCT/KR2021/009090 filed on Jul. 15, 2021. The entire contents of PCT International Application No. PCT/KR2021/009090 is hereby incorporated by reference.

### TECHNICAL FIELD

The present disclosure relates to a method, system, and non-transitory computer-readable recording medium for controlling a plurality of automated guided vehicles, and more particularly, to a method, system, and non-transitory computer-readable recording medium for controlling a plurality of automated guided vehicles so that the plurality of automated guided vehicles can move smoothly without colliding with each other in a space in which the plurality of automated guided vehicles are used.

### BACKGROUND

In recent years, automated guided vehicles (AGVs) are widely used to load materials and cargo thereon, move in an unmanned and automated driving manner, and transport the materials and cargo to a target place in workspaces such as factories and warehouses.

Techniques for preventing a collision in such a way that an automated guided vehicle has its own sensor and an anti-collision program built therein, when the automated guided vehicle working in a specific area is in close proximity to another automated guided vehicle or an obstacle, detects this and stops the movement thereof, and moves again after away from the other automated guided vehicle or the obstacle are known. However, if the movements of the automated guided vehicle are controlled in this way, there is a matter in that not only the movement efficiency is lowered due to frequent repetition of stop/operation, but also the overall work efficiency is significantly reduced.

Therefore, there is a demand for a control method and system capable of increasing work efficiency while preventing a collision between automated guided vehicles by integrally controlling the movements of the entire plurality of automated guided vehicles.

### SUMMARY

The present disclosure is to solve the above-described problems in the prior art, and has one object to provide a method, system, and non-transitory computer-readable recording medium for controlling a plurality of automated guided vehicles in which a collision is prevented by limiting the entry of another automated guided vehicle into an area in which there is a risk of a collision in accordance with a real-time position of an automated guided vehicle.

Also, the present disclosure has another object to increase the movement efficiency of the entire plurality of automated guided vehicles in such a way that the movement of the automated guided vehicle is controlled with reference to an area in which there is a collision risk.

Representative configurations of the present disclosure to achieve the above objects are described below.

A method for controlling a plurality of automated guided vehicles according to one embodiment of the present disclosure comprises the steps of: acquiring real-time information regarding positions of the plurality of automated guided vehicles moving along an automated guided vehicle route, setting a blocking area for each of the automated guided vehicles based on the information regarding the positions of the plurality of automated guided vehicles acquired in the step of acquiring the real-time information, and controlling movements of the plurality of automated guided vehicles with reference to the blocking area. Wherein, the automated guided vehicle route comprises a plurality of points and movement lines connecting two adjacent points among the plurality of points. In the step of setting the blocking area, when an automated guided vehicle is located at any one of the plurality of points, a point at which the automated guided vehicle is located and a movement line adjacent thereto are set as the blocking area, when the automated guided vehicle is located on any one of the movement lines, a movement line on which the automated guided vehicle is located and a movement line through which the automated guided vehicle has just passed are set as the blocking area, and the blocking area is set and changed in real time in accordance with the movement of each of the automated guided vehicles. In addition, in the step of controlling the movement of the plurality of automated guided vehicles, the movement of the automated guided vehicle attempting to enter the blocking area is controlled to stop and the movement of the automated guided vehicle is controlled to resume when the blocking area is released.

The method for controlling a plurality of automated guided vehicles according to one embodiment of the present disclosure may further comprises a step of setting the automated guided vehicle route in advance.

In the step of setting the blocking area in the method for controlling a plurality of automated guided vehicles according to one embodiment of the present disclosure, when an automated guided vehicle is located on any one of the movement lines, a movement line to which the automated guided vehicle will move next may be set as the blocking area in addition to the movement line on which the automated guided vehicle is located and the movement line through which the automated guided vehicle has just passed.

When the two or more movement lines join any one point among a plurality of points in the automated guided vehicle route according to one embodiment of the present disclosure, if any one of movement line of two or more movement lines is set as the blocking area, the rest of the movement lines may be also set as the blocking area.

A non-temporary computer-readable recording medium according to an example embodiment of the present disclosure may store a computer program for executing a method for controlling a plurality of automated guided vehicles.

A system for integrally controlling a plurality of automated guided vehicles according to one embodiment of the present disclosure comprises an information acquisition unit configured to acquire real-time information regarding positions of the plurality of automated guided vehicles moving along an automated guided vehicle route; a blocking area setting unit configured to set a blocking area for each of the automated guided vehicles based on the real-time information regarding the positions of the plurality of automated guided vehicles acquired by the information acquisition unit; and a movement control unit configured to control movements of the plurality of automated guided vehicles with reference to the blocking area. Wherein, the automated guided vehicle route comprises a plurality of points and movement lines connecting two adjacent points among the plurality of points. The blocking area setting unit sets a point at which the automated guided vehicle is located and a movement line adjacent thereto as the blocking area when an automated guided vehicle is located at any one of the plurality of points, and sets a movement line on which the automated guided vehicle is located and a movement line through which the automated guided vehicle has just passed as the blocking area when the automated guided vehicle is located on any one of the movement lines, and the blocking area is set and changed in real time in accordance with the movement of each of the automated guided vehicles. In addition, the movement control unit control to stop the movement of the automated guided vehicle attempting to enter the blocking area and to resume the movement of the automated guided vehicle when the blocking area is released.

According to one embodiment of the present disclosure, it is possible to effectively prevent a collision between automated guided vehicles by limiting the entry of another automated guided vehicle into an area in which there is a collision risk in accordance with real-time positions of a plurality of automated guided vehicles.

Also, it is possible to efficiently control the movements of the entire plurality of automated guided vehicles while preventing a collision by instructing an automated guided vehicle to move with reference to an area in which there is a collision risk.

### BRIEF DESCRIPTION OF THE DRAWINGS

FIG. 1 schematically shows a configuration of an entire system for controlling a plurality of automated guided vehicles according to one embodiment of the present disclosure.

FIG. 2 illustratively shows an internal configuration of a control system according to one embodiment of the present disclosure.

FIG. 3 illustratively shows a process of controlling a plurality of automated guided vehicles according to one embodiment of the present disclosure.

FIG. 4 illustratively shows a process of setting a blocking area for an automated guided vehicle according to one embodiment of the present disclosure.

FIGS. 5 to 9 illustratively show how a blocking area is set according to one embodiment of the present disclosure.

### DETAILED DESCRIPTION

Hereinafter, preferred embodiments of the present disclosure will be fully described in detail which is suitable for implementation by those skilled in the art to which the present disclosure pertains with reference to the accompanying drawings.

In order to clearly describe the present disclosure, a description of a portion not related to the present disclosure will be omitted, and throughout this disclosure, like reference numerals will be assigned to like elements. Further, a size, a thickness, a position, and the like of each element shown in the drawings are arbitrarily illustrated for convenience of description, and thus the present disclosure is not necessarily limited to those shown in the drawings. That is, it should be noted that specific shapes, structures, and features described herein can be changed and implemented from one embodiment to another embodiment without departing from the spirit and scope of the present disclosure, and a position or an arrangement of each element can also be changed without departing from the spirit and scope of the present disclosure.

Accordingly, the following detailed description is not to be taken in a limiting sense, and the scope of the present disclosure should be construed to include the scope of the appended claims and equivalents thereof. In the drawings, like reference numerals refer to the same or similar functions throughout the several views.

Configuration of the Entire System

FIG. 1 schematically shows a configuration of an entire system for controlling a plurality of automated guided vehicles according to one embodiment of the present disclosure.

As shown in FIG. 1, the entire system according to one embodiment of the present disclosure may include an automated guided vehicle 100, a control system 200, and a communication network 300.

The automated guided vehicle 100 according to one embodiment of the present disclosure is a device capable of moving along a predetermined route in an unmanned and automated driving manner and may communicate with the control system 200 through the communication network 300 and move/stop in accordance with an instruction from the control system 200. The automated guided vehicle 100 may include a space for loading a material, a driving device for movement, and the like.

An automated guided vehicle route which means a movement path for the automated guided vehicle 100 is composed of points and movement lines connecting two adjacent points. Here, the points are used for encompass places in which work may be performed using the automated guided vehicle 100 and places in which the automated guided vehicle 100 may stop and wait until the next movement. The automated guided vehicle route may be set in advance in accordance with the characteristics of a workplace in which the automated guided vehicles are operated and include closed paths composed of a plurality of points and a plurality of movement lines, as in one embodiment which will be described later.

On the other hand, according to one embodiment of the present disclosure, such an automated guided vehicle 100 may include an application for controlling the movement thereof. Such an application may be download from the control system 200 or an external application distribution server (not illustrated).

The control system 200 according to one embodiment of the present disclosure may communicate with a plurality of automated guided vehicles 100 through the communication network 300 to integrally control the automated guided vehicle 100. To be specific, the control system 200 may perform a function of acquiring real-time information regarding the positions of the plurality of automated guided vehicles 100 along the automated guided vehicle route, setting a blocking area which limits the entry of the automated guided vehicle on the basis of the acquired positions of the plurality of automated guided vehicles 100, and controlling the movements of the plurality of automated guided vehicles 100 with reference to the set blocking area.

The control system 200 has been described as above, which is an example. In addition, it is clear to those skilled in the art that at least some of the functions or constituent elements required for the control system 200 may be realized in the automated guided vehicle 100 described above or included in an external system (not illustrated) as needed.

The communication network 300 according to one embodiment of the present disclosure may be configured regardless of communication aspects such as wired communication or wireless communication and may include various communication networks such as a local area network (LAN), a metropolitan area network (MAN), and a wide area network (WAN). For example, the communication network 300 is a wireless data communication network and may be a network obtained by implementing a communication method in the related art at least in a part thereof such as wireless fidelity (WiFi) communication, WiFi-Direct communication, long term evolution (LTE) communication, Bluetooth communication (more specifically, Bluetooth low energy (BLE) communication), infrared communication, and ultrasonic communication.

Configuration of System which Controls Plurality of Automated Guided Vehicles

Hereinafter, an internal configuration of the control system 200 crucial for implementing the present disclosure and the functions of respective components thereof will be described.

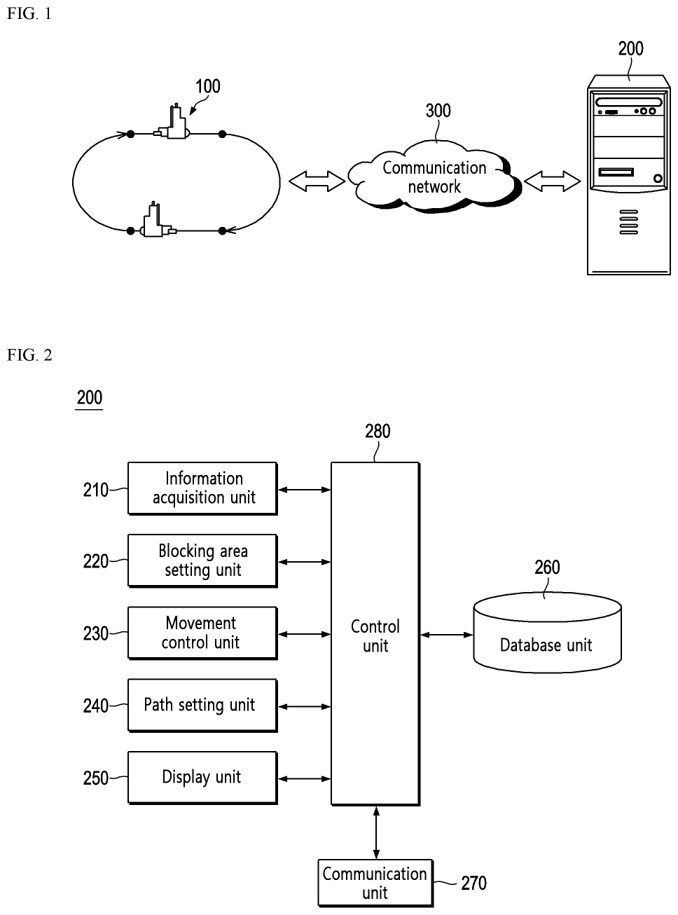

FIG. 2 illustratively shows an internal configuration of the control system according to one embodiment of the present disclosure. In addition, referring to FIG. 2, the control system 200 according to one embodiment of the present disclosure may comprise an information acquisition unit 210, a blocking area setting unit 220, a movement control unit 230, a path setting unit 240, a display unit 250, a database unit 260, a communication unit 270, and a control unit 280.

According to one embodiment of the present disclosure, at least some of the information acquisition unit 210, the blocking area setting unit 220, the movement control unit 230, the path setting unit 240, the display unit 250, the database unit 260, the communication unit 270, and the control unit 280 may be program modules which communicate with the external system (not illustrated). Such program modules may be included in the control system 200 in the form of an operating system, application program modules, and other program modules and may be physically stored in a variety of commonly known storage devices. Furthermore, such program modules may be stored in a remote storage device that may communicate with the control system 200. Meanwhile, such program modules may include, but not limited to, routines, sub-routines, programs, objects, components, data structures, and the like for preforming specific tasks or execute specific abstract data types as will be described below in accordance with the present disclosure.

The information acquisition unit 210 of the control system 200 according to one embodiment of the present disclosure may function to acquire real-time information regarding the position, the state, and the like of each of the automated guided vehicles. Here, the position of the automated guided vehicle refers to the position of the automated guided vehicle on the automated guided vehicle route. In addition, the information regarding the position of the automated guided vehicle acquired by the information acquisition unit 210 may include information regarding a point or a movement line on which the automated guided vehicle is located and a movement line through which the automated guided vehicle has just passed or a movement line to which the automated guided vehicle will move next. Furthermore, the information regarding the state of the automated guided vehicle acquired by the information acquisition unit 210 may include, for example, information such as an operation state, a charging state, and presence/absence of a failure for the automated guided vehicle.

The blocking area setting unit 220 of the control system 200 according to one embodiment of the present disclosure may function to set a blocking area on an automated guided vehicle route based on information regarding the position of the automated guided vehicle. To this end, the blocking area setting unit 220 may receive information regarding the position of the automated guided vehicle from the information acquisition unit 210. The blocking area is an area in which the entry of other automated guided vehicles is limited, if a certain area on the automated guided vehicle route is set as a blocking area, the entry of other automated guided vehicles into this area may be limited by the movement control unit 230 which will be described below. Meanwhile, the information regarding the position of the automated guided vehicle may be updated in real time and transmitted to the blocking area setting unit 220. Thus, a blocking area may also be set and changed in real time.

The movement control unit 230 of the control system 200 according to one embodiment of the present disclosure may function to control the movement of the automated guided vehicle with reference to the blocking area set by the blocking area setting unit 220. The movement control unit 230 may instruct an automated guided vehicle to move or stop so that the automated guided vehicle avoids the blocking area and the automated guided vehicle which receives a movement instruction may move without stopping or colliding with an obstacle until the movement of the automated guided vehicle to a point at which the work is scheduled is completed.

The movement control unit 230 may instruct an automated guided vehicle waiting to move after finishing work at a point to move. Whether the work of the automated guided vehicle at the point has been completed may be confirmed in various ways. For example, it is possible to determine whether the automated guided vehicle has finished the work in such a way that the automated guided vehicle which has finished the work at the point send a certain signal to the information acquisition unit.

The path setting unit 240 of the control system 200 according to one embodiment of the present disclosure may function to set an automated guided vehicle route that is a movement path of an automated guided vehicle. The automated guided vehicle route may be set in advance in accordance with a size of a workplace, the disposition of points, and the like or a pre-stored path may be loaded and used.

The display unit 250 of the control system 200 according to one embodiment of the present disclosure may function to display information regarding real-time locations and states of a plurality of automated guided vehicles as a map. Accordingly, a user can easily ascertain the positions of an entire automated guided vehicles and can efficiently distribute works and instruct the movement in consideration of the positions of the entire automated guided vehicles. Furthermore, when the movement of the automated guided vehicle is congested or when there is a malfunction in the automated guided vehicle, it may be quickly identified and dealt with.

The database unit 260 of the control system 200 according to one embodiment of the present disclosure may function to store data required for operating the control system 200. Data stored in the database unit 260 may include, for example, information regarding an automated guided vehicle route according to a workplace, a position of an automated guided vehicle acquired during a predetermined period, and a blocking area. The data stored in the database unit 260 may be load and used by the user to set an automated guided vehicle route, to understand the situation during controlling the movement of an automated guided vehicle, and the like.

The communication unit 270 of the control system 200 according to one embodiment of the present disclosure may function to allow data transmission/reception from/to the information acquisition unit 210, the blocking area setting unit 220, the movement control unit 230, the path setting unit 240, the display unit 250, and the database unit 260.

The control unit 280 of the control system 200 according to one embodiment of the present disclosure may function to control a flow of data between the information acquisition unit 210, the blocking area setting unit 220, the movement control unit 230, the path setting unit 240, the display unit 250, the database unit 260, and the communication unit 270. That is, the control unit 280 according to the present disclosure may control a flow of data from/to the outside of the control system 200, or a flow of data between the constituent elements of the control system 200, such that the information acquisition unit 210, the blocking area setting unit 220, the movement control unit 230, the path setting unit 240, the display unit 250, the database unit 260, and the communication unit 270 may carry out their particular functions, respectively.

Method for Controlling Plurality of Automated Guided Vehicles

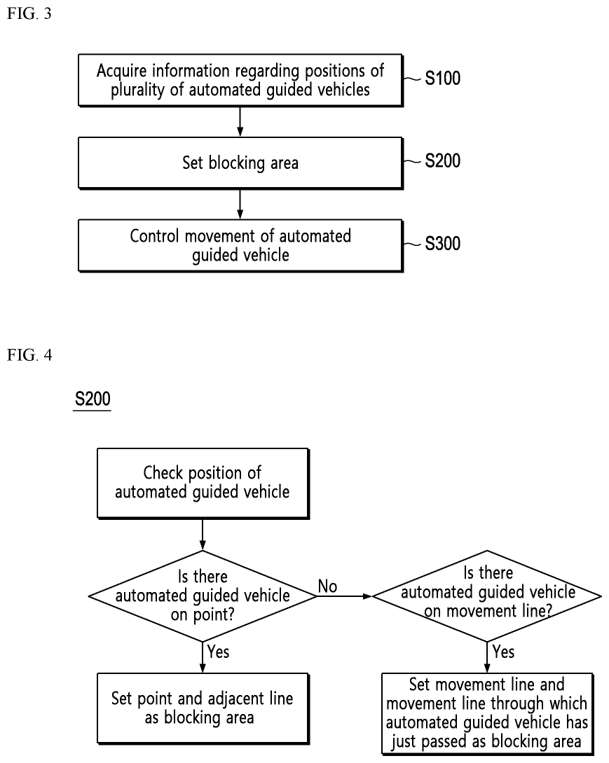

FIG. 3 illustratively shows a process of controlling a plurality of automated guided vehicles according to one embodiment of the present disclosure. Hereinafter, a method for controlling a plurality of automated guided vehicles according to one embodiment of the present disclosure will be described in detail with reference to this.

First, information regarding the position of each of the plurality of automated guided vehicles is acquired (S100). An automated guided vehicle moving along an automated guided vehicle route may be located at a point at which work may be performed or waited in a stationary state or on a movement line connecting adjacent points. The information regarding the position of the automated guided vehicle may be acquired from the information acquisition unit 210 of the control system 200 described above, and through this, a point or a movement line in which the automated guided vehicle is located can be specified. Furthermore, in this step, the movement line through which this automated guided vehicle has just passed and/or a movement line to which this automated guided vehicle will move can also be specified.

Meanwhile, a step of setting an automated guided vehicle route may be performed before acquiring information regarding the position of the automated guided vehicle. The automated guided vehicle route may be designed in accordance with the characteristics and the like of the workplace in which the automated guided vehicle is operated and may also be set using data relating to an automated guided vehicle route which is stored in advance.

Subsequently, a blocking area is set based on the position of the automated guided vehicle (S200). In this step, an area in which there is a risk of collision when another automated guided vehicle enters in accordance with the position of the automated guided vehicle is set as a blocking area.

FIG. 4 illustratively shows a process of setting a blocking area for an automated guided vehicle according to one embodiment of the present disclosure, and referring to this, in one embodiment, the blocking area is set differently in accordance with whether the automated guided vehicle is located on a point or movement line of an automated guided vehicle route.

To be specific, when the automated guided vehicle is located at any one of a plurality of points, a point at which the automated guided vehicle and a movement line adjacent thereto that is, a movement line through which the automated guided vehicle has just passed and a movement line to which the automated guided vehicle will move next are set as a blocking area. Furthermore, when the automated guided vehicle is located on the movement line, a movement line on which the automated guided vehicle is located and a movement line through which the automated guided vehicle has just passed are set as a blocking area. On the other hand, when the automated guided vehicle is located on the movement line, a movement line to which the automated guided vehicle will move next may be set as a blocking area in addition to the movement line on which the automated guided vehicle is located and the movement line through which the automated guided vehicle has just passed. Furthermore, a blocking area may be set in a pre-set manner in various situations such as when two or more movement lines join a certain point.

Subsequently, the movement of the automated guided vehicle is controlled with reference to the blocking area set in accordance with the position of the automated guided vehicle (S300). As described above, if a blocking area is set in accordance with the information regarding the real-time position of each of the automated guided vehicles on the automated guided vehicle route, the movement of the automated guided vehicle is controlled to avoid the blocking area. For example, when there is an automated guided vehicle which is attempting to enter a blocking area, the movement of the automated guided vehicle is stopped, and controlled to move again at the time when the blocking area is released. As such, the automated guided vehicle may move to a target place without risk of collision by blocking the entry of an automated guided vehicle into a blocking area having a risk of collision between automated guided vehicles in advance.

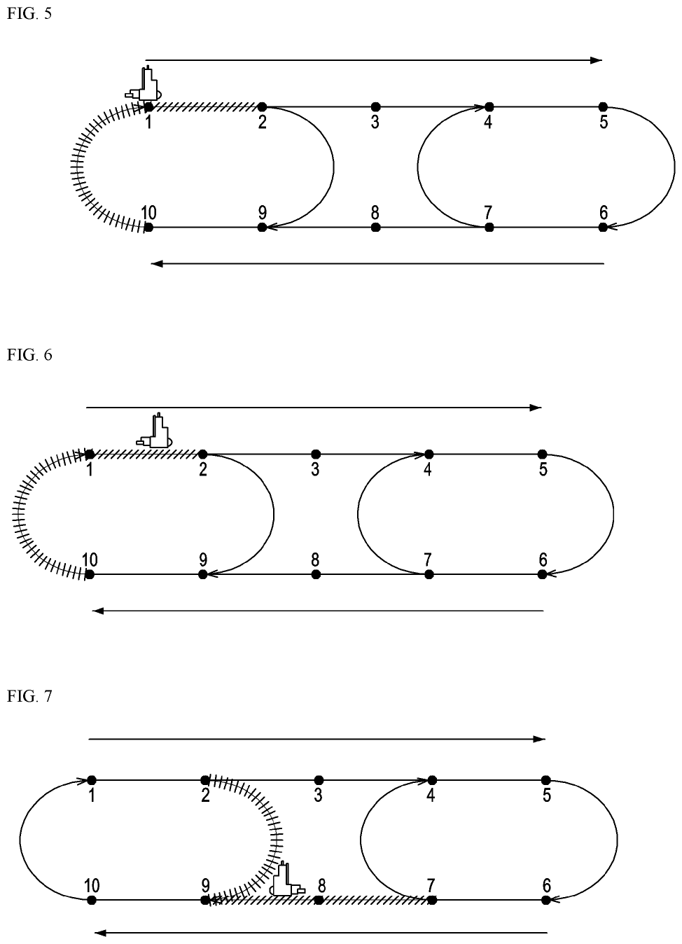

FIGS. 5 to 9 illustratively show how a blocking area is set according to one embodiment of the present disclosure. Hereinafter, one aspect in which a blocking area is set in accordance with a position of an automated guided vehicle on an automated guided vehicle route will be explained in detail.

FIG. 5 shows one aspect in which a blocking area is set when an automated guided vehicle is located at any one of a plurality of points. Referring to FIG. 5, when an automated guided vehicle is located at any one of the plurality of points, for example, a first point, two movement lines adjacent to the first point, that is, a movement line (1-2 movement line) connecting the first point and a second point and a movement line (10-1 movement line) connecting a tenth point and the first point are set as a blocking area. The reason why a blocking area is set in this way is that another automated guided vehicle is highly likely to collide or interfere with the automated guided vehicle when the other automated guided vehicle enters a movement line before or after a point at which the automated guided vehicle is located.

FIG. 6 shows one aspect in which a blocking area is set when an automated guided vehicle is located on a movement line connecting adjacent points, for example, when an automated guided vehicle is located on the movement line (1-2 movement line) connecting the first point and the second point, this movement line (1-2 movement line) and the movement (10-1 movement line) through which the automated guided vehicle has just passed are set as a blocking area. The reason why the previous movement line (10-1 movement line) as well as the movement line (1-2 movement line) on which this automated guided vehicle is located is set as the blocking area is that if an automated guided vehicle enters the previous movement line (10-1 movement line) when the automated guided vehicle is located at the beginning of this movement line (1-2 movement line) (i.e., portion adjacent to the first point), collision or interfere with the automated guided vehicle is likely to occur.

On the other hand, when the automated guided vehicle is located on the movement line (1-2 movement line) connecting the first point and the second point, movement lines (2-3 movement line and 2-9 movement line) to which this automated guided vehicle will move next are set as a blocking area in addition to this movement line (1-2 movement line) and the movement line (10-1 movement line) through which the automated guided vehicle has just passed. This is because when the automated guided vehicle is located at the end (that is, portion adjacent to the second point) of this movement line (1-2 movement line), there is a possibility of collision or interference if another automated guided vehicle is located on any one of the movement lines (2-3 movement line and 2-9 movement line) that the automated guided vehicle will soon enter.

FIG. 7 shows one aspect in which a blocking area is set to include a place in which two or more movement lines join one point. To be specific, as illustrated in FIG. 7, when the automated guided vehicle is located on the movement line (8-9 movement line) connecting an eighth point and the ninth point in an automated guided vehicle route in which two movement lines (2-9 movement line and 8-9 movement line) join a ninth point, as in one embodiment of FIG. 6 described above, this movement line (8-9 movement line) and the movement line (7-8 movement line) through which the automated guided vehicle has just passed are set as a blocking area. However, when the automated guided vehicle moves toward the ninth point along the 8-9 movement line, if there is an automated guided vehicle from the second point toward the ninth point, collision of the automated guided vehicle is likely to occur in the vicinity of the ninth point. Therefore, in this case, in addition to this movement line (8-9 movement line) in which the automated guided vehicle is located, the movement line (2-9 movement line) which meet this movement line at one point is also set as the blocking area to limit the entry of the automated guided vehicle. Furthermore, although not illustrated in the drawings, a blocking area may be set to further include a movement line (9-10 movement line) to which the automated guided vehicle will move. This is because, if an automated guided vehicle is located on the movement line (9-10 movement line) that the automated guided vehicle will soon enter when the automated guided vehicle is located at the end (i.e., portion adjacent to the ninth point) of this movement line (8-9 movement line), collision or interfere with the automated guided vehicle is likely to occur.

For the same reason, when the automated guided vehicle is located on the 9-10 movement line in FIG. 7, the 2-9 movement line that is one of the movement lines which join the ninth point is set as a blocking area.

Also, although not illustrated in the drawings, also when three or more movement lines join one point, it is possible to surely prevent collision between automated guided vehicles by setting a blocking area to include not only the movement line through which the automated guided vehicle passes but also the joining movement lines.

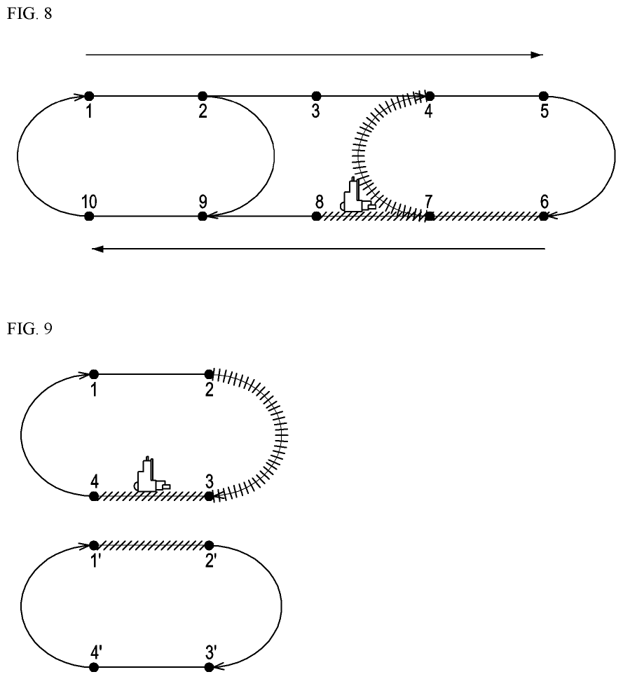

FIG. 8 shows one aspect in which a blocking area is set to include a place in which two or more movement lines are divided from one point. To be specific, when an automated guided vehicle is located on a movement line (7-8 movement line) connecting a seventh point and the eighth point in an automated guided vehicle route in which two movement lines (7-8 movement line and 7-4 movement line) are divided from the seventh point, as illustrated in the drawings, as in the example embodiment in FIG. 6 described above, this movement line (7-8 movement line) and a movement line (6-7 movement line) through which the automated guided vehicle has passed immediately before are set as a blocking area. On the other hand, if an automated guided vehicle is located on the 7-4 movement line when an automated guided vehicle is located on the 7-8 movement line, collision of the automated guided vehicle is likely to occur. Therefore, in this case, in addition to this movement line (7-8 movement line) in which the automated guided vehicle is located, the movement line (7-4 movement line) which meet this movement line at one point is also set as the blocking area to limit the entry of the automated guided vehicle. Furthermore, although not illustrated in the drawings, a blocking area may be set to further include a movement line (8-9 movement line) to which the automated guided vehicle will soon move.

FIG. 9 shows one aspect in which a blocking area is set to include a place in which two or more divided automated guided vehicle routes are adjacent to each other. There may be two or more divided automated guided vehicle routes in one workplace in which automated guided vehicles are operated in accordance with the characteristics of the workplace. In this case, also between automated guided vehicles located on different automated guided vehicle routes, collision or interfere between the automated guided vehicles is likely to occur in accordance with a distance between the automated guided vehicle routes, sizes of the automated guided vehicles, and the like. To be specific, when an automated guided vehicle is located on a movement line (3-4 movement line) connecting a third point and a fourth point as illustrated in the drawings, this movement line (3-4 movement line) and a movement line (2-3 movement line) through which the automated guided vehicle has passed immediately before are set as a blocking area, as in one embodiment in FIG. 6 described above. On the other hand, if another automated guided vehicle enters a movement line (1′-2′ movement line) on another automated guided vehicle route adjacent to this movement line (3-4 movement line) on which the automated guided vehicle is located, collision of the automated guided vehicle is likely to occur. Therefore, in addition to the automated guided vehicle route in which the automated guided vehicle is located, a movement line on another automated guided vehicle route adjacent to this movement line on which the automated guided vehicle is located is also set as the blocking area to limit the entry of the automated guided vehicle.

Information regarding the positions of the plurality of automated guided vehicles is updated in real time, and thus the set blocking area is also changed in real time. For example, when an automated guided vehicle is located on the movement line connecting the first point and the second point while an automated guided vehicle is moving from the first point to the second point, this movement line and a movement line through which the automated guided vehicle has passed immediately before are set as a blocking area, if the automated guided vehicle moves along this movement line and is located at the second point, the previously set blocking area is released and a movement line adjacent to the second point is set as a blocking area.

As such, according to one embodiment of the present disclosure, it is possible to efficiently control the movement of the entire plurality of automated guided vehicles while preventing a collision between automated guided vehicles by acquiring information regarding the positions of the plurality of automated guided vehicles in real time, setting a blocking area to include an area in which there is a collision risk, and limiting the entry of another automated guided vehicle.

Although the present disclosure has been described above in terms of specific items such as detailed constituent elements as well as the limited embodiments and the drawings, they are merely provided to help more general understanding of the present disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the present disclosure.

What is claimed is:

1. A method for controlling a plurality of automated guided vehicles, comprising the steps of:
acquiring real-time information regarding positions of the plurality of automated guided vehicles moving along an automated guided vehicle route;
setting a blocking area for each of the automated guided vehicles based on the real-time information regarding the positions of the plurality of automated guided vehicles acquired in the step of acquiring the real-time information; and
controlling movements of the plurality of automated guided vehicles with reference to the blocking area,
wherein the automated guided vehicle route comprises a plurality of points and movement lines connecting two adjacent points among the plurality of points,
wherein in the step of setting the blocking area, when an automated guided vehicle is located at any one of the plurality of points, a point at which the automated guided vehicle is located and a movement line adjacent thereto are set as the blocking area, when the automated guided vehicle is located on any one of the movement lines, a movement line on which the automated guided vehicle is located and a movement line through which the automated guided vehicle has just passed are set as the blocking area, and the blocking area is set and changed in real time in accordance with the movement of each of the automated guided vehicles, and
wherein in the step of controlling the movement of the plurality of automated guided vehicles, the movement of the automated guided vehicle attempting to enter a blocking area is controlled to stop and the movement of the automated guided vehicle is controlled to resume when the blocking area is released.

2. The method of claim 1, further comprising a step of:
setting the automated guided vehicle route in advance.

3. The method of claim 1, wherein in the step of setting the blocking area, when an automated guided vehicle is located on any one of the movement lines, a movement line to which the automated guided vehicle will move next is set as the blocking area in addition to the movement line on which the automated guided vehicle is located and the movement line through which the automated guided vehicle has just passed.

4. The method of claim 1, wherein, in case that two or more movement lines join any one point among the plurality of points in the automated guided vehicle route, if any one of movement line of the two or more movement lines is set as the blocking area, a rest of the movement lines are also set as the blocking area.

5. A non-temporary computer-readable recording medium storing a computer program for executing the method according to claim 1.

6. A system for integrally controlling a plurality of automated guided vehicles, comprising:
an information acquisition unit configured to acquire real-time information regarding positions of the plurality of automated guided vehicles moving along an automated guided vehicle route;
a blocking area setting unit configured to set a blocking area for each of the automated guided vehicles based on the real-time information regarding the positions of the plurality of automated guided vehicles acquired in the information acquisition unit; and
a movement control unit configured to control movements of the plurality of automated guided vehicles with reference to the blocking area,
wherein the automated guided vehicle route comprises a plurality of points and movement lines connecting two adjacent points among the plurality of points,
wherein the blocking area setting unit sets, when an automated guided vehicle is located at any one of the plurality of points, a point at which the automated guided vehicle is located and a movement line adjacent thereto are set as the blocking area, when the automated guided vehicle is located on any one of the movement lines, a movement line on which the automated guided vehicle is located and a movement line through which the automated guided vehicle has just passed are set as the blocking area, and the blocking area is set and changed in real time in accordance with the movement of each of the automated guided vehicles, and
wherein the movement control unit controls to stop the movement of the automated guided vehicle attempting to enter the blocking area and to resume the movement of the automated guided vehicle when the blocking area is released.
